(19) United States
(12) Patent Application Publication
(10) Pub. No.: US 2020/0165436 A1
(43) Pub. Date: May 28, 2020

(54) METHOD AND APPARATUS FOR MODIFIED PVC PASTE RESIN

(71) Applicant: Jun Ma, Shanghai (CN)

(72) Inventor: Jun Ma, Shanghai (CN)

(21) Appl. No.: 16/200,294

(22) Filed: Nov. 26, 2018

(51) Int. Cl. C08L 27/22; C08L 83/04; C08K 5/00; C08K 11/00; C08K 3/36; C08L 77/00; C08L 71/02; C08K 5/20; C08J 3/00; C08J 3/12; C08J 3/18

(52) U.S. Cl. CPC C08L 27/22; C08L 83/04; C08K 5/0016; C08K 11/00; C08K 3/36; C08L 77/00; C08J 2383/04; C08K 5/20; C08J 3/005; C08J 3/12; C08J 3/18; C08J 2327/22; C08L 71/02

(57) ABSTRACT

The present invention discloses a modified polyvinyl chloride (PVC) paste resin and a method of making thereof. The PVC paste resin is prepared by mixing a PVC paste resin with polysiloxane (PBP), for example polyborodimethylsiloxanes.

### RELATED APPLICATIONS

The present application claims priority to U.S. Provisional Application Ser. No. 62/591,096, entitled “METHOD AND APPARATUS FOR MODIFIED PVC PASTE RESIN” by Ma, which was filed on Nov. 27, 2017 the text and drawings of which are incorporated by reference into this application in their entirety.

### BACKGROUND

Polysiloxane (PBP) based impact resistant materials have attracted much attention in recent years. The material is a clay material with a typical shear thickening effect. The physical-chemical capability of the material is stable and the impact resistant capability of the material is exceptional. However, the clay state determines if deformation caused by an impact can be recovered after the impact force is removed. Because of this, it is difficult to apply such material to various articles used for safety. To solve the problem, it is possible to combine the material with resin or elastomer to make a composite material system. By doing so, it is possible to achieve recoverable deformation, while still absorbing an impact force. Green et al., in patent publication US20070029690A, describes how a linear low density polyethylene (LLDPE) and a polyester elastomer are used as a substrate. A composite material results by kneading, at high temperature, a quantity of PBP with a quantity of a substrate material. The resulting composite material's impact energy absorption performance is improved.

Polyvinyl chloride (PVC) paste is made by mixing and stirring PVC paste resin powder and some amount of plasticizer. A high elasticity, leather-like material can be obtained by processing the PVC paste at high temperature. As can be appreciated, such PVC paste is widely used in products such as gloves, toys, and tools by dipping the products in the PVC paste. How to improve the impact resistance and protective performance of PVC paste products has been a hotspot in this field. However, since PVC paste is a liquid raw material, and PBP is a gel state, mixing of the PBP with the PVC paste cannot be achieved by the high temperatures kneading process described by Green et al., see supra.

### BRIEF DESCRIPTION OF THE DRAWINGS

Several alternative embodiments will hereinafter be described in conjunction with the appended drawings and figures, wherein like numerals denote like elements, and in which:

FIGS. 1-4 are flow diagrams that depict alternative example method for making a modified PVC paste resin by dissolving PBP in a hydroxyl silicone oil; and

FIGS. 5-13 are flow diagrams that depict various alternative example methods wherein a modified PVC paste resin is prepared using a mechanical mixing technique.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “ . . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

According to the present method and various alternatives thereto, normal PVC paste is combined with a PBP. The resulting product comprises a modified polyvinyl chloride (PVC) paste that, when subjected to shear or impact forces, can absorb and dissipate a part of the energy by an abrupt change in its viscosity. The elastomer properties of the matrix-material PVC paste resin allows the composite material to recover its initial morphology under the elasticity effect of the PBP after a non-destructive impact. The modified PVC paste resin has better impact resistance and protective performance than the unmodified PVC paste resin. In one variation of the present method, the PBP comprises polyborodimethylsiloxanes (PBDMS). Where the claims read on the use of a PBP, as a general class, these claims are to include the specific PBP polyborodimethylsiloxanes.

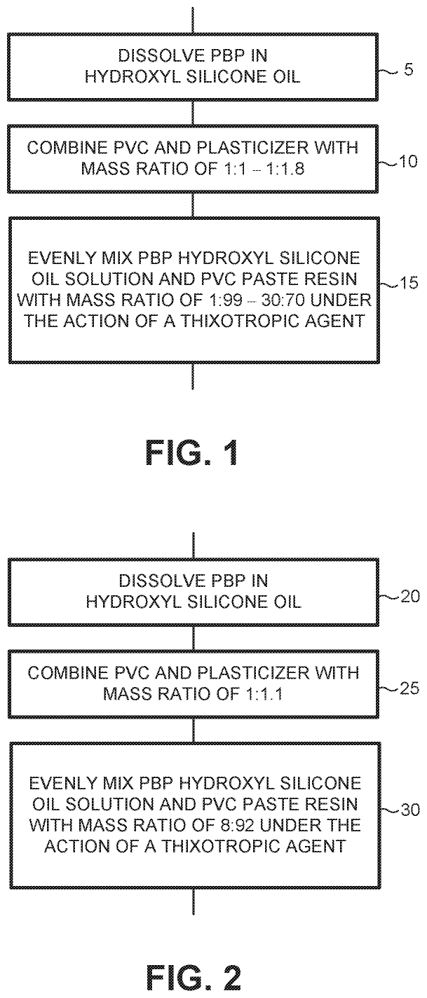

FIGS. 1-4 are flow diagrams that depict alternative example method for making a modified PVC paste resin by dissolving PBP in a hydroxyl silicone oil. In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

One example method comprises a first step wherein hydroxyl silicone oil is used to dissolve Polysiloxane (PBP) until the hydroxyl silicone oil is substantially saturated (step 5). The present method also comprises preparation of a PVC paste resin by combining PVC and a plasticizer with mass ratio comprising 1:1.2 (step 10). In one alternative example method, preparation of the PVC paste resin from PVC and a plasticizer is accomplished by, and thereby comprises using a plasticizer with mass ratio comprising in the range of 1:1-1:1.8.

The present method also comprises a third step wherein the saturated PBP hydroxyl silicone oil solution (obtained from step 5) and PVC paste resin (obtained from step 10) are mixed under the action of a thixotropic agent (step 15) with a mass ratio of 1:99-30:70. In order to achieve useful results, mixing of the two intermediate compounds, i.e. hydroxyl silicone oil substantially saturated with PBP and the PVC paste resin, is accomplished at a temperature in the range of 190 C-260 C. In one alternative example method, the thixotropic agent comprises at least one or more of hydrogenated castor oil, a thixotropic SiO₂ and/or a polyamide wax.

In one alternative example method, the mass ratio of the saturated PBP hydroxyl silicone oil solution when combined with the PVC paste resin comprises 1:99. In yet another alternative method, the mass ratio of the PBP solute in hydroxyl silicone oil to PVC paste resin varies in a range comprising 1:99-30:70. The PBP modified PVC composite is obtained by stirring the saturated PBP hydroxyl silicone oil solution and the PVC paste evenly. It should be appreciated that the stirring ratio of the PBP solute and the PVC paste must be adjusted according to the saturation level of PBP in the hydroxyl silicone oil. This applies to all variations of the present method.

In another alternative method (FIG. 2), hydroxyl silicone oil is used to dissolve PBP until the hydroxyl silicone oil is substantially saturated (step 20). This alternative method also comprises making a PVC paste resin by combining PVC and a plasticizer with mass ratio of 1:1.1 (step 25). A third step included in this example method provides for mixing, under the action of thixotropic agent, the saturated PBP hydroxyl silicone oil solution (resulting from step 20) and PVC paste resin (resulting from step 25) (step 30). The mass ratio of the saturated PBP hydroxyl silicone oil solution combined with the PVC paste resin comprises 8:92. This PBP modified PVC composite is obtained by stirring the saturated PBP hydroxyl silicone oil solution and the PVC paste evenly. The temperature for this process must be elevated to the range herein discussed.

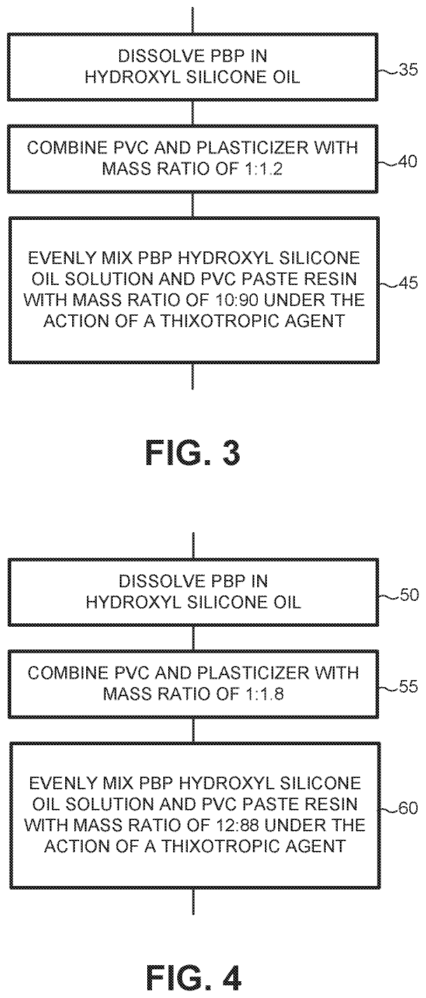

FIG. 3 depicts an alternative method that comprises a first step where hydroxyl silicone oil is used to dissolve PBP until the hydroxyl silicone oil is substantially saturated (step 35). This method also comprises a second step where PVC paste resin is made by combining PVC and a plasticizer using a mass ratio comprising 1:1.2 (step 40). A third step included in this example method comprises mixing the saturated PBP hydroxyl silicone oil solution (obtained from step 35) and PVC paste resin (obtained from step 40) under the action of thixotropic agent (step 45). The mass ratio of the saturated PBP hydroxyl silicone oil solution combined with the PVC paste resin comprises 10:90. The PBP modified PVC composite is obtained by stirring the saturated PBP hydroxyl silicone oil solution and the PVC paste evenly.

FIG. 4 depicts another alternative method that comprises a first step wherein a hydroxyl silicone oil is used to dissolve a PBP until the hydroxyl silicone oil is substantially saturated (step 50). This alternative method further comprises a second step where a PVC paste resin is made by combining PVC and a plasticizer with mass ratio comprising 1:1.8 (step 55). The present method also comprises a third step where the saturated PBP hydroxyl silicone oil solution (obtained from step 50) and PVC paste resin (obtained from step 55) are mixed under the action of thixotropic agent (step 60). The mass ratio of the saturated PBP hydroxyl silicone oil solution combined with the PVC paste resin comprises 12:88. The PBP modified PVC composite is obtained by stirring the saturated PBP hydroxyl silicone oil solution and the PVC paste evenly.

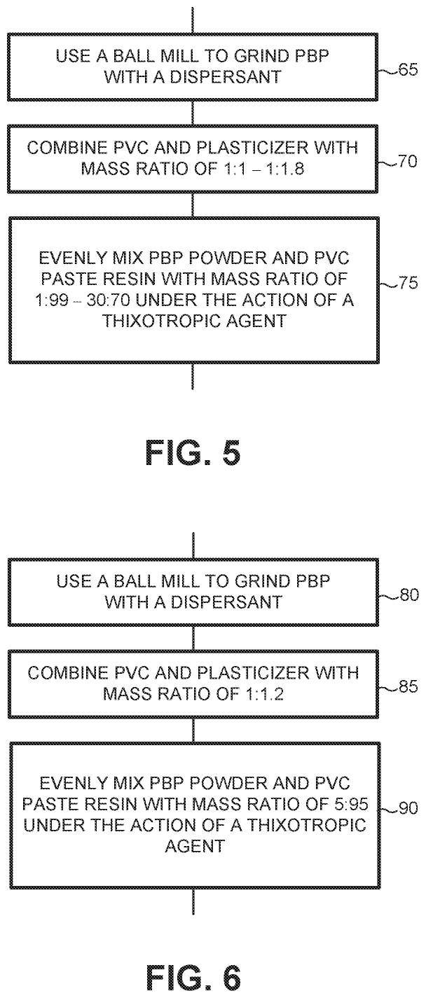

FIGS. 5-13 are flow diagrams that depict various alternative example methods wherein a modified PVC paste resin is prepared using a mechanical mixing technique. This alternative example method comprises a first step where PBP is substantially ground to a powder under the presence of a dispersant using a ball mill. The resultant powder, according to one variation of the present method, comprises particles of approximately 50 uM or less. In one alternative method the dispersant comprises one or more of OP-10 and/or ethylene-bis-stearamide (step 65). OP-10 comprises polyethylene glycol tert-octylphenyl ether with the molecular formula 4-(C8H17)C6H4(OCH2CH2)nOH, n=10.

This alternative example method comprises a second step where a PVC paste resin is made from a PVC and a plasticizer with mass ratio comprising 1:1-1:1.8 (step 70). This alternative example method also comprises a third step wherein PBP powder (obtained from step 65) and PVC paste resin (obtained from step 70) are mixed with mass ratio within a range of 1:99-30:70. The PBP modified PVC composite is obtained by stirring the PBP powder and PVC paste resin evenly under temperature treatment, substantially similar to 190-260° C. (step 75).

FIG. 6 depicts one alternative example method that comprises a first step where PBP is substantially ground to a powder under the presence of a dispersant by using a ball mill (step 80). In yet another alternative example method, the dispersant comprises at least one or more of OP-10 and/or ethylene-bis-stearamide. This alternative example method comprises a second step where a PVC paste resin is made from PVC and a plasticizer with mass ratio comprising 1:1.2 (step 85). This example method also comprises a third step wherein PBP powder (obtained from step 80) and PVC paste resin (obtained from step 85) are mixed using a mass ratio comprising 5:95. The PBP modified PVC composite is obtained by stirring PBP powder and PVC paste resin evenly (step 90).

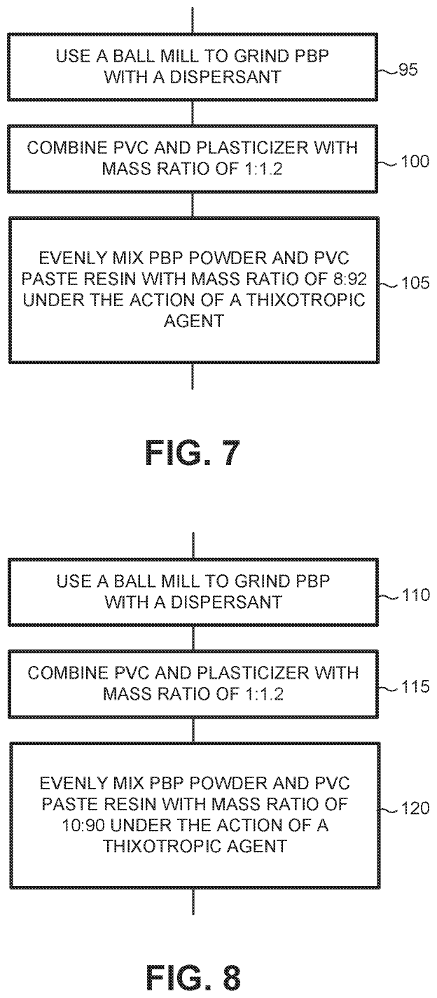

FIG. 7 is a flow diagram that depicts one alternative example method that comprises a first step wherein PBP is substantially ground to a powder under the presence of a dispersant by using a ball mill (step 95). In yet another alternative example method, the dispersant comprises at least one or more of OP-10 and/or ethylene-bis-stearamide. The present method comprises a second step where a PVC paste resin is made from a PVC and a plasticizer with mass ratio comprising 1:1.2 (step 100). This alternative example method also comprises a third step wherein PBP powder (obtained from step 95) and PVC paste resin (obtained from step 100) are mixed with mass ratio comprises 8:92. The PBP modified PVC composite is obtained by stirring the PBP powder and PVC paste resin evenly (step 105).

FIG. 8 is a flow diagram that depicts one alternative example method that comprises a first step wherein PBP is substantially ground to a powder under the presence of a dispersant by using a ball mill (step 110). In yet another alternative example method, the dispersant comprises at least one or more of OP-10 and/or ethylene-bis-stearamide. The present method comprises a second step where PVC paste resin is made from a PVC and a plasticizer with mass ratio comprising 1:1.2 (step 115). This alternative example method also comprises a third step wherein PBP powder (obtained from step 110) and PVC paste resin (obtained from step 115) are mixed with mass ratio comprising 10:90. The PBP modified PVC composite is obtained by stirring the PBP powder and PVC paste resin evenly (step 120).

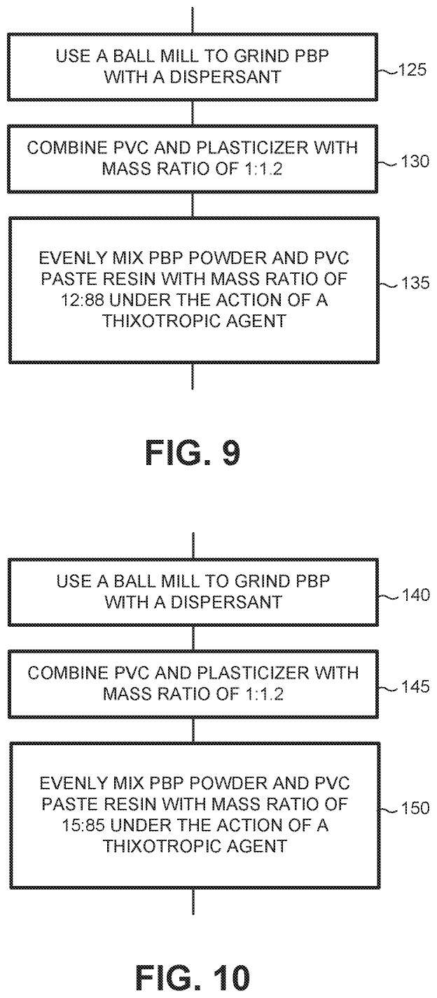

FIG. 9 is a flow diagram that depicts one alternative example method that comprises a first step where PBP is substantially ground to a powder under the presence of a dispersant using a ball mill (step 125). In yet another alternative example method, the dispersant comprises at least one or more of OP-10 and/or ethylene-bis-stearamide. This alternative example method comprises a second step wherein a PVC paste resin is made from a PVC and a plasticizer with mass ratio comprising 1:1.2 (step 130). The present method also comprises a third step where PBP powder (obtained from step 125) and PVC paste resin (obtained from step 130) are mixed with mass ratio comprising 12:88. The PBP modified PVC composite is obtained by stirring the PBP powder and PVC paste resin evenly (step 135).

FIG. 10 is a flow diagram that depicts one alternative example method that comprises a first step where PBP is substantially ground to a powder under the presence of a dispersant using a ball mill (step 140). In yet another alternative example method, the dispersant comprises at least one or more of OP-10 and/or ethylene-bis-stearamide. This alternative example method comprises a second step wherein a PVC paste resin is made from a PVC and a plasticizer with mass ratio comprising 1:1.2 (step 145). This example method also comprises a third step where PBP powder (obtained from step 140) and PVC paste resin (obtained from step 145) are mixed with mass ratio comprising 15:85. The PBP modified PVC composite is obtained by stirring the PBP powder and PVC paste resin evenly (step 150).

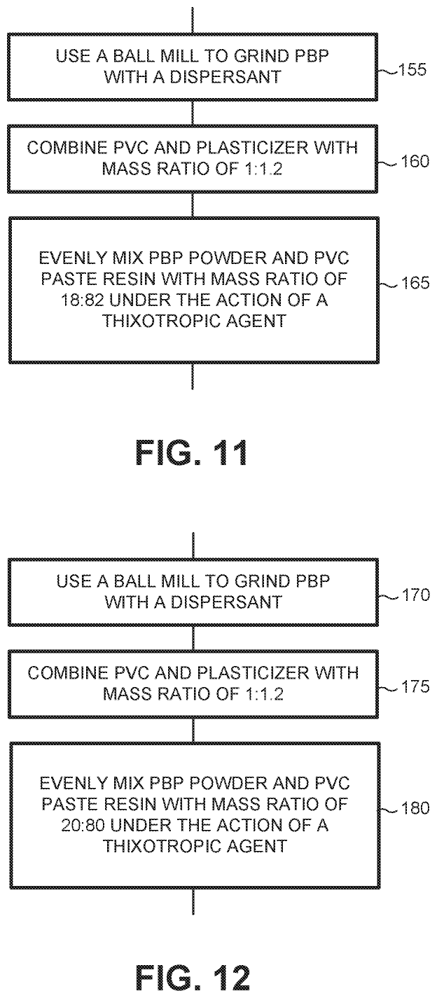

FIG. 11 is a flow diagram that depicts one alternative example method that comprises a first step where PBP is substantially ground to a powder under the presence of a dispersant using a ball mill (step 155). In yet another alternative example method, the dispersant comprises at least one or more of OP-10 and/or ethylene-bis-stearamide. The present alternative example method comprises a second step wherein PVC paste resin is made from a PVC and a plasticizer with mass ratio comprising 1:1.2 (step 160). This alternative example method also comprises a third step where PBP powder (obtained from step 155) and PVC pasted resin (obtained from step 160) are mixed with mass ratio comprising 18:82. The PBP modified PVC composite is obtained by stirring the PBP powder and PVC pasted resin evenly (step 165).

FIG. 12 is a flow diagram that depicts one alternative example method that comprises a first step wherein PBP is substantially ground to a powder under the presence of a dispersant using a ball mill (step 170). In yet another alternative example method, the dispersant comprises at least one or more of OP-10 and/or ethylene-bis-stearamide. This alternative example method comprises a second step where a PVC paste resin is made from PVC and a plasticizer with mass ratio comprising 1:1.2 (step 175). The present alternative example method also comprises a third step wherein PBP powder (obtained from step 170) and PVC paste resin (obtained from step 175) are mixed with mass ratio comprising 20:80. The PBP modified PVC composite is obtained by stirring the PBP powder and PVC paste resin evenly (step 180).

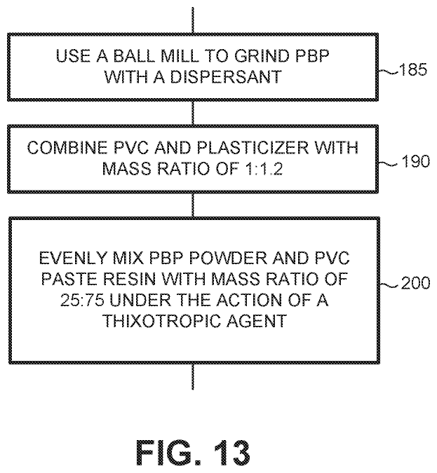

FIG. 13 is a flow diagram that depicts one alternative example method that comprises a first step where PBP is substantially ground to powder under the presence of a dispersant using a ball mill (step 185). In yet another alternative example method, the dispersant comprises at least one or more of OP-10 and/or ethylene-bis-stearamide. This alternative example method comprises a second step where PVC paste resin is made from a PVC and a plasticizer with mass ratio comprising 1:1.2 (step 190). This alternative example method also comprises a third step wherein PBP powder (obtained from step 180) and PVC paste resin (obtained from step 185) are mixed with mass ratio comprising 25:75. The PBP modified PVC composite is obtained by stirring the PBP powder and PVC paste resin evenly (step 200).

Various samples, representing various alternative embodiments of the composite material, were subject to impact stress using the method specified in EN14120. Using a 5 kg “falling hammer”, impact energy of 17.5 joules was applied to various samples. When compared with PVC, the PBP modified PVC composite material impact resistance was substantially improved.

What is claimed is:

1. A modified PVC paste resin comprising a compounded of a PVC paste resin and a PBP.

2. The modified PVC paste resin of claim 1, characterized in that the mass ratio of the PBP and the PVC paste resin comprises a ratio in the range of 1:99-30:70.

3. The modified PVC paste resin of claim 1, characterized in that the modified PVC paste resin further includes a plasticizer.

4. The modified PVC paste resin of claim 3, characterized in that the mass ratio of the PVC paste resin and the plasticizer comprises a ratio in the range of 1:1-1:1.8.

5. A method of making a modified PVC paste resin, comprising:
dissolving PBP in hydroxyl silicone oil until the hydroxyl silicone oil is substantially saturated;
preparing a PVC paste resin by combining PVC and a plasticizer using a mass ratio comprising a ratio in the range of 1:1-1:1.8; and
mixing the substantially saturated PBP hydroxyl silicone oil solution and the PVC paste resin under the action of thixotropic agent, wherein a mass ratio of the substantially saturated PBP hydroxyl silicone oil solution and the PVC paste resin is in a range comprising 1:99-30:70.

6. The method of claim 5 wherein, the thixotropic agent is comprises at least one or more of hydrogenated castor oil, a thixotropic SiO₂ and/or a polyamide wax.

7. The method of claim 5 wherein the degree of polymerization of the hydroxyl silicone oil is in a range comprising 20-10,000.

8. The method of claim 5 wherein mixing the saturated PBP hydroxyl silicone oil solution and the PVC paste resin under the action of thixotropic agent is accomplished at a temperature in a range comprising 190-260° C.

9. A method of making a modified PVC paste resin comprising:
grinding a quantity of PBP into a powder under the presence of a dispersant by using a ball mill;
preparing a PVC paste resin from a PVC and a plasticizer with mass ratio in a range comprising 1:1-1:1.8; and
mixing the PBP powder and the PVC paste resin with mass ratio in a range comprising 1:99-30:70.

10. The method of claim 9 wherein the dispersant comprises at least one or more of OP-10 and Ethylene-Bis-Stearamide.
